(19) United States
(12) Patent Application Publication
(10) Pub. No.: US 2026/0101884 A1
(43) Pub. Date: Apr. 16, 2026

(54) DEVICE, METHOD, AND SYSTEM TO SELECTIVELY CONTROL THE SPREAD OF AN INVASIVE SPECIES

(71) Applicant: GERARD H. BENCEN, GAINESVILLE, FL (US)

(72) Inventor: GERARD H. BENCEN, GAINESVILLE, FL (US)

(21) Appl. No.: 19/354,396

(22) Filed: Oct. 9, 2025

Related U.S. Application Data
(60) Provisional application No. 63/705,726, filed on Oct. 10, 2024.

(51) Int. Cl. A01M 25/00

(52) U.S. Cl. CPC A01M 25/00

(57) ABSTRACT

A system, method, and device to selectively contain the spread of an invasive species. The device according to this invention: (1) is securely fixable to or implantable in a prey of the invasive species; (2) includes a trigger mechanism specific to the invasive species to release a kill mechanism; and (3) includes a kill mechanism which, if triggered, selectively kills said invasive species.

### FIELD OF THE INVENTION

Method, device, and system for selective control of an invasive species.

### BACKGROUND OF THE INVENTION

Burmese pythons have become an invasive species which is wreaking havoc with the natural habitats and ecosystems in the Florida everglades. However, no efficient method has been devised to date to contain this invasion, see Guzy et al: “Burmese pythons in Florida: A synthesis of biology, impacts, and management tools”, NeoBiota 80:1-119 (2023), which concludes:

“Burmese pythons in southern Florida represent one of the most intractable invasive-species management issues across the globe. The problem stems from a unique combination of inaccessible habitat with the cryptic and resilient nature of pythons that do very well in the subtropical environment of southern Florida, rendering them extremely difficult to detect. We have documented extensive direct alteration of the native food web as well as some aspects of the basic biology of these giant constrictors over the past two decades, while extensively exploring methods to capture and remove this damaging species (Table 4). However, very low individual detection probabilities for Burmese pythons remain the greatest obstacle to developing landscape-scale control programs. Controlling population expansion and minimizing the impact of pythons to natural resources is a pressing concern as billions of dollars have been spent in attempts to restore the Everglades after more than 100 years of extensive wetland alteration (Davis and Ogden 1994; Clarke and Dalrymple 2003; Finkl and Makowski 2017). Consequently, invasive species, including Burmese pythons, represent one of the greatest threats to restoration success (e.g., Center et al. 2012). Biological invasions have cumulatively caused at least $1.22 trillion in economic losses in the United States over the past six decades, with the largest impacts coming from mammalian, plant, and insect invaders (Fantle-Lepczyk et al. 2022). For example, in the southeastern United States, costs to control feral pigs and citrus canker have totaled $460 and $420 million, respectively (Fantle-Lepczyk et al. 2022). Excluding research expenditures, considerably less has been spent to manage Burmese pythons, with approximately $10.6 million since 2004 (USFWS 2012). Although a wide variety of techniques have been employed to catch pythons across southern Florida, many of these tools have not been evaluated rigorously, largely because of difficulty detecting pythons. Although rapid response to reports of individual pythons in new areas is ongoing, there have not been any concerted efforts aimed at suppression or eradication of python populations, even in limited areas. Cost-effective control methods and a better understanding of impacts on natural resources may help to inform application of limited resources and development of mitigation strategies. Because of individual heterogeneity in snake detection (e.g., Tyrrell et al. 2009; Christy et al. 2010; Yackel Adams et al. 2019), integration of multiple control tools (Závorka et al. 2018), including existing tools as well as new methods, will likely be necessary to suppress the python population and quantify the level of suppression. Over the longer term, genetic biocontrol tools may provide an avenue towards eradication, but these tools are currently in the early stages of development for pythons. Therefore, future research to better understand and optimize implementation of existing technologies and transferability in new locations (e.g., where/when certain control methods work best, cost/benefit analysis) can help to fully evaluate python impacts. As such, important avenues of research include research into basic reproductive life history and estimation of key vital rates such as survival to project population growth rates over time to understand the impacts of management actions on abundance. Overall, eradication of pythons in southern Florida is likely impossible. Suppression of the python population, even at local scales, will require strategic coordination of researchers, land managers, funding, public outreach, implementation of several different complementary tools, and rigorous evaluation of these tools.”

In the absence of an effective control mechanism, the State of Florida has initiated an annual “Python Challenge”, (see https://flpythonchallenge.org/), according to which “python hunters” compete to eliminate as many pythons as possible. In 2024, the $10,000 winner had culled 20 pythons. Even if hundreds of hunters were to engage in this process, it is unlikely to significantly control the rate of python invasion due to absolute numbers being estimated in the tens of thousands, if not more.

In 2023, (see https://phys.org/news/2023-02-scientists-lure-burmese-pythons-radio.html) University of Florida wildlife scientists scouted for Burmese pythons in the Everglades “using previously captured pythons to lure, locate and learn how the invasive species is thriving in the Everglades. This latest effort is a large-scale python removal scout program led by UF/IFAS scientists in collaboration with the United States Geological Survey (USGS), Fort Collins Science Center, South Florida Water Management District (SFWMD) and the Florida Fish and Wildlife Conservation Commission (FWC). Researchers are using pythons captured by SFWMD's Python Elimination Program and FWC's Python Action Team to study python biology further as they leverage radio telemetry technology during the species mating and breeding seasons to remove pythons. Scientists lure Burmese pythons using radio telemetry during mating/breeding season, stating “Our study links python ecology with removal efforts,” said Melissa Miller, project lead and research assistant scientist specializing in invasion biology at UF/IFAS Fort Lauderdale Research and Education Center.” This allows for long-term, in-depth research projects, which are critical to understanding cryptic, long-lived species such as Burmese pythons, all while continuing to find and remove pythons from the Everglades.” Adult male and female pythons, provided by the water management district's Python Elimination Program and FWC's Python Action Team, are implanted with tracking devices and released into Everglades Francis S. Taylor Wildlife Management Area. As pythons form mating aggregations consisting of multiple male suitors lured by a female, tracking them during their breeding season can increase the number of snakes removed. The tracked males can help scientists locate female pythons capable of producing up to 100 eggs, which can be captured and removed. Sex pheromones secreted by tracked females lure males naturally and female pythons can provide important life history information concerning reproduction and survivorship that can be used to help estimate the number of pythons in the Everglades. The tracking devices will lead researchers to the snakes, allowing them to record behavior and document reproductive data such as nesting sites, clutch size, hatchlings and how many survive. The project will help inform management efforts by increasing our understanding of how pythons use a predominant habitat type—sawgrass marsh interspersed with tree islands—within the Everglades. The team has started tracking eight adult pythons, which will provide data on habitat use and python abundance that will help natural resource managers evaluate control efforts, said Miller, who is also affiliated with the UF/IFAS Croc Docs. “As administering a python radiotelemetry project in the Everglades requires many resources, the project will also assess innovative tools to reduce those resources while allowing for increased data collection,” Miller said.”

In a further study, in 2023/2024, (see https://www.nbcmiami.com/news/local/pythons-tracked-across-florida-by-eaten-possums-with-gps-collars/2977643/), it was reported: “Pythons Tracked Across Florida by Eaten Possums With GPS Collars. Wildlife researchers studying mammals in Key Largo have discovered a potentially groundbreaking—if not heartbreaking—way to locate and kill invasive Burmese pythons, especially the big ones. A team observing raccoon and possum behavior along urban and wilderness fringes of Crocodile National Wildlife Refuge fitted dozens of the mammals with GPS collars, and tracked their locations for months. In September, about five months into the study, one of the possum collars sent out a mortality signal, triggered by lack of movement—maybe it was hit by a car, maybe a local dog killed it. But then, a few hours later, the collar started moving again. The researchers had a hunch that the possum suffered a brutal fate. “That's the signature signal that they got eaten by a snake,” said Michael Cove, curator of mammals at the North Carolina Museum of Natural Sciences, one of the partners on the study. He and his research partners from the U.S. Fish & Wildlife Service and Southern Illinois University suspected the snake sat around and digested the possum, and then started moving again. But even with the tracker, it would take them time to confirm their hunch—Key Largo is essentially a giant fossilized coral reef with a labyrinth of underground pockets and caves. “This thing was underground. It took a month of tracking the snake underground (to capture it).” When they finally yanked it out of the ground, they discovered a 12-foot-long, 66-pound female full of egg follicles. Large females like this can lay close to 100 eggs, and are the holy grail for python hunters. Removing them from the ecosystem is like removing dozens, if not hundreds, of future snakes. The team euthanized her, opened her up and retrieved the collar, which they hope to fit onto another possum soon. Though the possum's demise was grim—pythons coil around their prey, tightening the grip every time the animal exhales, eventually suffocating it—the death proved that wildlife officials can find big pythons by tracking their prey. Cove and his research partners hope the method can help control the explosive population growth of the invasive snake, which has decimated ecosystems in South Florida for decades. Indigenous to southeast Asia, Burmese pythons likely slithered their way into the Everglades in the 1990s via the exotic pet trade. They've thrived, establishing breeding populations as far south as Key Largo and as far north as the Loxahatchee National Wildlife Refuge in western Palm Beach County. Cove said that the problem is so severe in Everglades National Park that “there are no more mammals to put these collars on.” The largest invasive python ever recorded in Florida was 18 feet long. Proof of concept, and a glitch. The study occurred on the boundary between the human world and wilderness, and looked at what happens when raccoons and possums are “dumpster diving and eating all the cat food that people put out for them instead of eating the native seeds and fruits,” Cove said. Both species consume a lot of native fruits and defecate the seeds out in different areas, becoming important seed dispersers. A parallel goal, though, was to learn more about pythons if the mammals were eaten. “If we could catch a snake in the act, it could lead to management and removal of the pythons,” Cove said. The first possum was proof of concept—the collar survived the crush of the snake, and the snake didn't pass the collar, giving the scientists time to find it. Two weeks ago, a second collar stopped moving, then started again, indicating that a big raccoon had been eaten by a snake. This time they found the snake more quickly: jackpot, a 77-pound behemoth also full of egg follicles. On Wednesday, yet another collar emitted a mortality signal and started moving again. But by the time researchers reached the tracker, all they found was a collar in a pile of snake poop. The python, apparently one massive enough to pass the device, was still out there. “This was really crushing to me that we didn't pull out this giant monster snake that ate this latest opossum,” Cove said. They now know that there's a sense of urgency, especially if the snake is large enough to pass the collar. Of the 43 collars they've deployed, they know three were ingested by pythons, but six more have simply disappeared. The research team now wonders if they were consumed by pythons who then moved beyond the study's geographic range. Cruel or crucial? Is tracking prey to find pythons tantamount to using innocent raccoons and possums as bait? “That's a question we're getting—don't you feel guilty for putting these animals at risk? ” Cove said. He said the collared animals are not at greater risk—they go about their business as they normally would, and researchers ensure the collars don't hinder their movements. Unfortunately the pythons sometimes intercept them. “We're not doing anything but observing the animals doing their natural thing, and they're unfortunately getting consumed and it's leading to these python removals,” he said. As it stands, no one has invented an effective way to remove invasive pythons. Authorities have tried myriad methods, including tracking them with beagles, holding a python-catching derby called Python Challenge—last year's 10-day challenge resulted in 231 snakes killed, a small fraction of the “tens of thousands” the U.S. Geological Survey estimates are lurking wild in the state.”

In a further publication on this matter in 2023, (see https://www.livescience.com/gps-tagged-mammals-used-to-catch-pythons and see FIG. 4), it was reported as follows:

“GPS-tagged possums and raccoons could be sacrificed to capture Florida's invasive pythons. Researchers accidentally discovered that GPS-tagged mammals can help locate Florida's invasive Burmese pythons, which are destroying local ecosystems. An X-ray image shows a GPS-collar, which once sat around the neck of a possum, inside a dead Burmese python that swallowed the small mammal. (Image credit: Southern Illinois University). Researchers have stumbled across an effective new way of finding giant Burmese pythons, which are invasive to the U.S. and have been decimating Florida's local ecosystems. While carrying out an unrelated study into the movements and behaviors of raccoons and possums in Key Largo, an island off the southern Florida coast, researchers found that the GPS collars they attached to the small mammals could track the invasive Burmese pythons (Python bivittatus) after the supersized snakes swallowed the tagged animals whole. The team first made this serendipitous discovery in September 2022, when a GPS collar attached to a possum gave off a mortality signal, which is emitted when an animal goes several hours without moving when it should be active. But after a few hours, the collar began to move again. Over the next few days, the collar emitted several other mortality signals between short periods of movement. The researchers realized that the only explanation for this unusual behavior was if the possum had been eaten by a python, the researchers wrote in a statement. After tracking the collar for around a month, the team found the python, a 12-foot-long (3.7 meters) female weighing a hefty 66 pounds (30 kilograms), which was then euthanized. A necropsy of the snake revealed that the GPS collar was still intact and fully functional inside the snake, even though the possum had long been digested, the researchers wrote in the statement. In January, researchers successfully tracked another python, a 77-pound (35 kg) female of unknown length, after the girthy serpent swallowed a raccoon with a GPS collar. And on February 8, the researchers tracked down another GPS collar in a pile of snake poop, which had only recently been passed by another large python, The South Florida Sun-Sentinel reported. In total, three of the 42 GPS collars attached to mammals by researchers have been ingested by snakes, and another six have gone missing. Although it's not possible to definitively say what happened to the missing collars, the researchers suspect that pythons have swallowed them and since moved outside of the study area. Pesky pythons. Burmese pythons are massive serpents from Southeast Asia that invaded Florida in the early 1970s after being released as part of the exotic pet trade. The largest Burmese python found in Florida so far was an 18-foot-long (5.5 m) giant weighing a scale-tipping 215 pounds (98 kg) that was caught and killed in June 2022. The pythons have been extremely damaging to Florida's ecosystems because they are voracious eaters, reproduce rapidly and have no natural predators. As a result, wildlife officials are legally required to kill the snakes if they find them in the wild (and it is safe to do so). In certain areas, such as Everglades National Park, “there are no more mammals to put these collars on, “because the snakes have decimated local populations”, study researcher Michael Cove, curator of mammals at the North Carolina Museum of Natural Sciences in Raleigh, told The South Florida Sun-Sentinel. In other areas, however, the new tracking technique might work, especially when it comes to locating the snakes in underground tunnels. The team wants to continue using GPS collars to track Burmese pythons and are currently planning a new project with local agencies. “We need everything that we can find to remove as many pythons as possible,” Cove said.
i) Most recently, (see for example, https://abcnews.go.com/US/florida-snake-hunters-deploy-robotic-rabbits-capture-invasive/story?id=124376519), it has reported by Julia Jacobo, Aug. 5, 2025, 4:08 PM that:

“Florida snake hunters deploy robotic rabbits to capture invasive Burmese pythons; Researchers are looking for innovative ways to eradicate the invasive species.

Robot rabbits deployed to capture Burmese pythons. Robot rabbits deployed to capture Burmese pythonsA team dedicated to controlling populations of invasive Burmese pythons in Florida has deployed another unique method to find the elusive predators: robotic rabbits. A team dedicated to controlling populations of invasive Burmese pythons in South Florida has deployed another unique method to find the elusive predators: robotic rabbits. The robots are remote-controlled, solar-powered and designed to look like marsh rabbits, a preferred choice of prey for the pythons, according to the South Florida Water Management District, which is funding the project as part of its Python Elimination Program. Researchers designed the devices to produce a heat signature and emit a smell designed to attract the pythons, according to the utility company. They are also equipped with cameras to monitor for the pythons'movements and alert officials when one is detected—who can then send out a snake wrangler to detect and euthanize the animals. The robots were strategically placed throughout South Florida, according to the utility company. “We want to capture all of the processes that an actual rabbit would give off,” said Robert McCleery, a wildlife ecologist at the University of Florida, told the Palm Beach Post. Scientists at the University of Florida conducted the research, which was partly funded by the FWC. The South Florida Water Management District is funding the experiment. “Our partners have allowed us to trial these things that may sound a little crazy,” McCleery said. “Working in the Everglades for ten years, you get tired of documenting the problem. You want to address it.” The researchers replaced the stuffing in 40 toy rabbits with electrical components powered by solar energy and waterproofed them to withstand the rain and humidity, according to the Post. This isn't the first time snake hunters have used creative means to capture their prey. In 2020, the FWC deployed python-sniffing detector dogs to track pythons in South Florida. In 2022, University of Florida researchers put live rabbits in cages in the Everglades to lure the snakes. Over 90 days, nine rabbit pens lured 22 pythons, leading the snakes to stay in the area for more than an hour on average, according to a state report. Trackers have been placed on dozens of preferred python prey, such as rabbits, raccoons and opossums, which lead snake hunters to the pythons after they've swallowed the prey. Officials around the state pay bounty hunters to help control Burmese python populations and have attached tracking devices to male snakes, which leads them to egg-laying females. The introduction of Burmese pythons has decimated the local ecosystem in South Florida as they breed rapidly and compete with native wildlife for food, according to the U.S. Geological Survey. An estimated 180,000 were brought into the country between 1975 and 2018, according to the U.S. Geological Survey. Many entered the ecosystem through accidental or intentional release. As of 2000, the species had established a self-sustaining breeding population in the South Florida ecosystem, according to the USGS. The species is now distributed across more than 1,000 square miles of South Florida, including all of the Everglades National Park and across the southern coast to Rookery Bay National Estuarine Research Reserve, according to the USGS. But Burmese pythons are notoriously difficult to detect and capture, experts say. Detectability of Burmese pythons is an estimated 1% to 3%, meaning out of 100 snakes in a survey area, there could be a chance of spotting between one and three individuals, research has shown. At Everglades National Park, the frequency of Burmese python detection is about one python per eight hours of searching, according to the U.S. Fish and Wildlife Service. The U.S. banned the import of Burmese pythons in 2012. But chances of eradication are likely low at this point, according to the USGS. At least 76 prey species have been found in the guts of Burmese pythons over the past several decades, including mammals, birds, iguanas and alligators, according to USGS scientists. A 2012 study found that raccoon populations in the state had declined 99.3% since 1997, while opossums saw a decline of 98.9% and bobcats an 87.5% decline. Marsh rabbits, cottontail rabbits and foxes have effectively disappeared, a 2015 study found. In December 2022, a group of biologists stumbled upon a nearly 15-foot Burmese python in the midst of devouring an adult white-tailed deer. Black rats seem to be the only species of mammal resistant to the pythons. Also an invasive species, they arrived centuries ago aboard ships from Europe. They reproduce quickly and can scavenge carcasses as well as eat plants, insects and scraps from humans—allowing them to thrive, according to the USGS. But native predators may be starting to fight back, according to researchers who have documented cases of alligators, cottonmouth snakes and bobcats killing Burmese pythons.”

It has long been known that Acetaminophen is highly toxic to certain snakes. See, for example: “Acetaminophen as an oral toxicant for Nile monitor lizards (Varanus niloticus) and Burmese pythons (Python molurus bivittatus)”, Wildlife Research, 2010, 37, 215-222, by Richard E. Mauldin A, B and Peter J. Savarie A., which reported, as follows:

“Context. Invasive species are a growing global problem. Biological invasions can result in numerous harmful impacts on local ecologies, and non-native herpetofauna are frequently ignored. Nile monitor lizards (Varanus niloticus) and Burmese pythons (Python molurus bivittatus, recently reassessed as Python bivittatus bivittatus), have become established in southern Florida. Both are large, semi-aquatic predators that pose serious threats to a variety of threatened and endangered species, as well as to the unique ecology of the area.

Aims. Acetaminophen (CAS#103-90-2), a lethal oral toxicant for the invasive brown treesnake (Boiga irregularis) on Guam, was investigated as a possible toxicant in juvenile Burmese pythons and Nile monitors.

Methods. Dead neonatal mouse (DNM) baits containing 0, 10, 20, or 40 mg acetaminophen were force-fed to Nile monitors, whereas DNM containing doses of 0, 20, 40, or 80 mg were freely consumed by Burmese pythons. Subjects were frequently observed post-treatment for general condition and position, with special attention paid to activity (if any), behaviour, respiration, bleeding, emesis, ataxia, and mortality.

Key results. In Nile monitors, acetaminophen doses of 10, 20, or 40 mg resulted in 0, 50 and 100% mortality, respectively.

In Burmese pythons, doses of 20, 40, or 80 mg resulted in 14.3, 85.7 and 100% mortality, respectively. No mortality was observed in control individuals of either species. A negative correlation between dosage (mg kg−1) and time-to-death was observed in both species. Dosages ranging from 522 to 2438 mg kg−1 and 263 to 703 mg kg−1 were uniformly lethal to monitors and pythons, respectively. Neither species exhibited signs of pain or discomfort following acetaminophen treatment.

Conclusions. Acetaminophen is an effective toxicant in juvenile Nile monitors and Burmese pythons. Further investigation into acetaminophen toxicity in adults of these species is merited.

Implications. Although further investigation into adult lethal dosages and strategies to optimize bait deployment while minimizing secondary hazards is required, acetaminophen may have a role to play in the control of these invasive species in Florida.”

It is now even known why these reptiles are unable to metabolize this phenolic compound—see “Phylogenetic origins for severe acetaminophen toxicity in snake species compared to other vertebrate taxa”, Comparative Biochemistry and Physiology Part C: Toxicology & Pharmacology Volume 215, January 2019, Pages 18-24, Peter van den Hurk, Harold M. I. Kerkkamp, which concludes: “Based on the investigations presented here, snake species do not have a functional phenol-type glucuronidation enzyme, and they are also lacking acetylation activity. These observations were in concordance with the lack of genomic coding sequences for these enzymes. The lack of these enzymes make snakes very susceptible to toxicity of phenolic compounds like acetaminophen, and explains the observed methemoglobinemia observed in brown tree snakes exposed to acetaminophen. While the toxic effects of acetaminophen in snakes appear to be the same as has been observed in cats and other felines, the underlying mechanism is different in that snakes appear to be missing the gene for a phenol-type UGT, whilst in felines this gene has mutated into a pseudogene. It is unclear if snakes ever had a functional phenol-type UGT gene, and further comparisons of genomic information and enzyme activities with other reptilians could shed more light on the phylogenetic history of these enzymes.”

Finally, it is noted that in US 2022/0339112, an ingestible drug delivery system is disclosed that allows targeted drug delivery to large snakes and reptiles while passing through mammals without delivering the drug via the difference in digestion resistance times between snakes and mammals. A crush resistant shell prevents the drug from being released prematurely by the chewing action of the mammal.” Thus far, take-up of this technology has not been identified.

Accordingly, while many studies are underway to locate and contain this invasive species, efforts at producing a safe, broadly deployable and effective means for containing, never mind eliminating, this invasive species, has yet to be found. The present disclosure addresses this need.

### SUMMARY OF THE INVENTION

A system, method, and device to selectively contain the spread of an invasive species. The device according to this invention: (1) is securely fixable to or implantable in a prey of the invasive species; (2) includes a trigger mechanism specific to the invasive species to release a kill mechanism; and (3) includes a kill mechanism which, if triggered, selectively kills said invasive species.

Essentially, then, the “prey” whether any form of animal or animatronic or alternative prey form, whether alive or deceased or synthetically constructed, is a “Trojan horse”, referred to herein as the Trojan prey.

As this disclosure, for exemplification of the working principles suggested herein, heavily focuses on Burmese and reticulated pythons, for ease of reference and concision, from herein, these invaders are also referred to herein as as “Brp(s)”.

Use of living natural prey of Brp, while at first blush seems cruel, on further thought, is a mechanism to re-establish the eco-system with animals that have been depleted by the invasive species. It is a way for these former constituents of the ecosystem to “fight back” and reclaim their former territory. Handled carefully and intelligently, a mix of keystone species and the network species that formerly constituted the Florida everglades ecosystem can be used to titrate down the invasive species. Each one is a little “kamikaze” or “Trojan horse”, or “Trojan prey”, and each time such prey is consumed, without knowing it, it becomes the instrument of the invader's defeat.

Naturally, if the Brps would take euthanized prey, there is no shortage of euthanized domestic animals across Florida. Unfortunately, it seems that Brps kill their prey by contraction until the heart beat stops. This has led to the so-called animatronic bunnies mentioned in the Background above. Naturally, if the Brps take those bunnies, or a more “organic” decoy, with a heat signature and beating heart or heart simulator, then use of the present invention in combination with with such prey overcomes the thought of sending prey out to a not so lovely execution by the Brps.

If Brps only take living prey, then animals that would otherwise be euthanized could be put to good use as a first line combative force. Included in this group would be such “nuisance animals” as the bandit raccoons, rats, mice, and the like. Possums, of course, are key players in various ecosystems, and could be pressed into service to help re-establish a vibrant ecosystem in the everglades.

In a first embodiment, the invasive species is a Burmese or reticulated python, (i.e. Brps), both of which are invasive, non-native species in the Florida Everglades. In this embodiment, the trigger mechanism is a pressure sensitive mechanism, such as a capsule, associated with the prey, which is only triggered to release its contents upon a given amount of constrictive pressure being applied to said prey of Burmese or reticulated pythons, i.e. Brps. The kill mechanism which, if triggered, includes an adequate amount of a toxicant, as specific to the invasive species as possible, in toxicity, dose, rate of release and the like. For example, acetaminophen is highly toxic to Burmese or reticulated pythons but is relatively benign to mammals (with the exception of felines), birds, or other predatory animals, which in any event (e.g. “gators”, everglades small mammals, such as rodents, rabbits, mice, ad the like, possums, raccoons, would either swallow such a capsule whole or would simply reject it as non-consumable foreign matter. Absent crushing, the capsule remains intact and contains whatever toxicant is contained, leaving the non-target predator unscathed. Further, the dose of the toxicant or rate of release, such as by coating, may be made sufficiently specific to the susceptibilities of the Brps that even if an off target species were to break and consume the toxicant, it would not be lethal or disabling to such off target species. Those of ordinary skill in the art could achieve such results without undue experimentation, based on the disclosure provided herein.

In a further embodiment, the pressure sensitive mechanism is a sealed container, such as a capsule, or the like containing the toxicant which has been made susceptible to breakage and release of the contained toxicant when exposed to adequate pressure, by scoring, or designing the capsule from materials or interconnection of materials which on repeat testing preferably inside a surrogate prey, breaks or otherwise cracks to release its contents upon application of constrictive force by a Brp. Naturally, these results could further be confirmed under test conditions with captive Brps and provision of different Trojan prey options.

In a further embodiment, the pressure sensitive mechanism is a sealed container, such as a capsule, or the like, containing adequate amounts of toxicant to specifically euthanize a Brp, which has been made susceptible to breakage and release of the contained toxicant by pressurizing the interior of said capsule containing the toxicant, such that breakage of the capsule occurs upon additive constrictive pressure metered to a particular required additional amount of pressure deliverable only by a certain size, age, or mass of Brp, to essentially burst and release its contents.

In a further embodiment according to this invention, the device according to this invention: (1) is securely fixable to or implantable in a prey of the invasive species; (2) includes a trigger mechanism specific to the invasive species to release a kill mechanism; (3) includes a euthanasia mechanism which, if triggered, selectively kills said invasive species; and (4) a locatable tag, such as a radio frequency transmitter or the like. Those skilled in the art of tracking animals tagged with some form of beacon will be able to provide the most cost-effective technology, now known or which later comes into being.

The tracker may be used for every Trojan prey, to confirm proper operation of the system, or only in a certain percentage of prey.

### BRIEF DESCRIPTION OF THE DRAWINGS

FIG. 1A shows a 1081 g juvenile Burmese python (Python molurus bivittatus) constricting a lab rat (Rattus norvegicus) weighing 99 g, the constricting python coiling around and squeezing prey animals, which exerts pressure on the prey that scales positively with snake diameter; FIG. 1B shows the scaling relationship between peak constriction pressure and snake diameter. See Penning.

FIG. 2 show constriction pressure which scales differently in Python reticulatus and P. molurus bivittatus than in other species. The interspecific slope (dashed line) from Moon and Mehta (2007) represents 30 snakes from 12 species, ranging in size from 0.85 to 12.5 cm in diameter. Blood pressure values (top bar, systolic; bottom bar, diastolic) are from mice, rats, rabbits, sheep and humans (Flindt, 2003). See Penning.

FIG. 3 shows an X-ray image of a GPS-collar, which once sat around the neck of a possum, inside a dead Burmese python that swallowed the small mammal. (Image credit: Southern Illinois University). See https://www.nbcmiami.com/news/local/pythons-tracked-across-florida-by-eaten-possums-with-gps-collars/2977643/

FIG. 4A shows a first embodiment of the device and system according to this invention, in which only the sealed protective sheath is scored to be subject to pressure specific release of the toxicant, while in FIG. 4B, both the toxicant container/capsule, and the protective sheath are scored, to ensure release. The capsule itself may seal in the toxicant until crushed, without the need for a sheath.

FIG. 5A shows a further embodiment of this invention in which a tube is seeded with toxicant, such as acetaminophen, and the entire tube is pressurized. FIG. 5B shows then segmentation of into separated, pressurized, capsules. FIG. 5C shows individually separated sealed capsules at each under pressure such that added constriction pressure causes each capsule to pop or explode, releasing the toxicant into the prey which is then consumed by the Brps.

### DETAILED DISCLOSURE OF PREFERRED EMBODIMENTS OF THE INVENTION This invention is a system, method, and device to selectively contain the spread of an invasive species. The system and device according to this invention: (1) is securely fixable to a prey of the invasive species; (2) includes a trigger mechanism specific to the invasive species to release a kill mechanism; and (3) includes a kill mechanism which, if triggered, selectively kills said invasive species. In a further embodiment, a fourth element is included wherein the prey is also equipped with a tracking beacon.

In a first embodiment, the invasive species is a Burmese or reticulated python, Brp(s) both of which are invasive, non-native species in the Florida Everglades.

In further embodiments, the present invention is applicable by those skilled in the art following the present disclosure to (1) securely fix the device to a prey of the invasive species; (2) include a trigger mechanism specific to the invasive species to release a kill mechanism; and (3) provide a kill mechanism which, if triggered, selectively kills said invasive species.

In a preferred embodiment, the trigger mechanism is a pressure sensitive mechanism which is only triggered upon a given amount of constrictive pressure being applied to expose the kill mechanism.

In a preferred embodiment, the kill mechanism which, if triggered, includes an adequate amount of acetaminophen which is highly toxic to Burmese or reticulated pythons, but which is relatively benign to mammals, which are able to metabolize acetaminophen. Those skilled in the art will appreciate that other toxicants may be used, and, indeed, pressure sensitive activation of a powerful electric charge from a capacitor attached to a prey or implanted therein, adequate to kill a python. Alternatively, the pressure sensitive kill mechanism my deploy a mechanical kill mechanism, such as a small explosive charge, or deployment of a knife, blade, prong, or the like to pierce the snake from the inside-preferably by “pithing” the snake's brain upon ingestion of the prey and associated python kill mechanism. These latter kill methods are more likely to cause suffering to a python, and therefore, use of a python specific toxicant which is only activated and exposed to the python's digestive system when the python has released the toxicant from its implanted container on a prey, or attached to a harness on a prey, by crushing its prey.

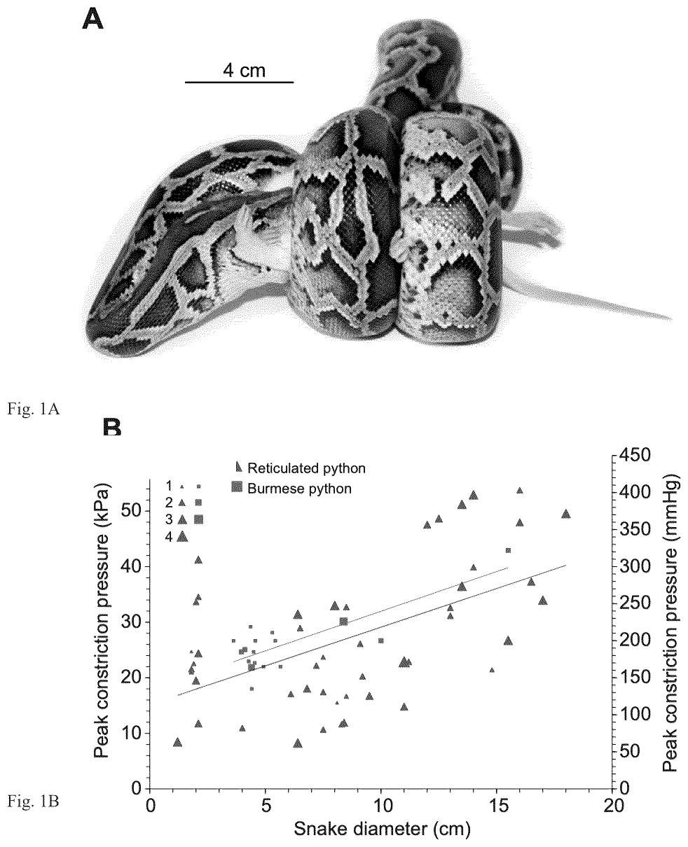

In “The big squeeze: scaling of constriction pressure in two of the world's largest snakes, Python reticulates and Python molurus bivittatus”, authored by David A. Penning, Schuyler F. Dartez, and Brad R. Moon, Journal of Experimental Biology (2015) 218, 3364-3367, hereafter and above, “Penning”), the contraction pressure of these snakes was quantitated. FIG. 1A shows a python coiled about a prey, and FIG. 1B shows the the scaling relationship between peak constriction pressure and snake diameter. It is disclosed there that “Reticulated and Burmese pythons both constricted the prey vigorously using coils of 1-4 loops (FIG. 1). Reticulated pythons exerted maximum pressures of 8.27-53.77 kPa, with larger individuals exerting significantly higher peak pressures than smaller individuals (constriction pressure=15.17+diameter×1.39; R²=0.29, F_{1,46}=19.06, P<0.0001; FIG. 1). Burmese pythons constricted with maximum pressures of 18.0-42.93 kPa, with larger individuals exerting significantly higher peak pressures than smaller individuals (constriction pressure=17.7+diameter×1.42; R²=0.61, F_{1,15}=26.56, P<0.0002; FIG. 1).” It is shown in FIG. 1B that compression forces of between about 10 kPa and the above noted maxima are common among such pythons.

In the present invention, this data is put to good use in constructing a frangible toxicant container which breaks to expose the toxicant, only when a sufficient constriction pressure is applied to the toxicant container. Thus, per the present invention, a frangible toxicant container adhered to a prey of a python is broken only when the python has exerted a minimum of about 10 kPa, thereby preventing the possibility of another species, unable to exert such forces to crush the frangible toxicant container to reveal the toxicant. No other species native to the Florida everglades is known to exert such powerful constriction forces on its prey prior to consumption, making this approach exceptionally selective to large pythons and nothing else. Accordingly, those skilled in the art, based on this disclosure, are able to prepare sealed toxicant containers which break and release the toxicant, or which sense a given pressure and release the toxicant, within pressure ranges as reported herein.

“Prey” as used herein encompasses any form of animal or animatronic or alternative prey form, whether alive, deceased, or synthetically constructed. Each prey as used herein is a “Trojan horse”, or more accurately, a Trojan prey.

As this disclosure, for exemplification of the working principles suggested herein, heavily focuses on Burmese and reticulated pythons, for ease of reference and concision, from herein, these invaders are also referred to herein as as “Brp(s)”. Use of living natural prey of Brp, while at first blush seems cruel, on further thought, is a mechanism to re-establish the eco-system with animals that have been depleted by the invasive species. It is a way for these former constituents of the ecosystem to “fight back” and reclaim their former territory. Handled carefully and intelligently, a mix of keystone species and the network species that formerly constituted the Florida everglades ecosystem can be used to titrate down the invasive species. Each one is a little “kamikaze” or “Trojan horse”, or “Trojan prey”, and each time such prey is consumed, without knowing it, it becomes the instrument of the invader's defeat. Naturally, if the Brps would take euthanized prey, there is no shortage of euthanized domestic animals across Florida. Unfortunately, it seems that Brps kill their prey by contraction until the heart beat stops. This has led to the so-called animatronic bunnies mentioned in the Background above. Naturally, if the Brps take those bunnies, or a more “organic” decoy, with a heat signature and beating heart or heart simulator, then use of the present invention in combination with with such prey overcomes the thought of sending prey out to a not so lovely execution by the Brps.

If Brps only take living prey, then animals that would otherwise be euthanized could be put to good use as a first line combative force. Included in this group would be such “nuisance animals” as the bandit raccoons, rats, mice, and the like. Possums, of course, are key players in various ecosystems, and could be pressed into service to help re-establish a vibrant ecosystem in the everglades.

In a first embodiment, the invasive species is a Burmese or reticulated python, (i.e. Brps), both of which are invasive, non-native species in the Florida Everglades. In this embodiment, the trigger mechanism is a pressure sensitive mechanism, such as a capsule, associated with the prey, which is only triggered to release its contents upon a given amount of constrictive pressure being applied to said prey of Burmese or reticulated pythons, i.e. Brps. The kill mechanism which, if triggered, includes an adequate amount of a toxicant, as specific to the invasive species as possible, in toxicity, dose, rate of release and the like. For example, acetaminophen is highly toxic to Burmese or reticulated pythons but is relatively benign to mammals (with the exception of felines), birds, or other predatory animals, which in any event (e.g. “gators”, everglades small mammals, such as rodents, rabbits, mice, ad the like, possums, raccoons, would either swallow such a capsule whole or would simply reject it as non-consumable foreign matter. Absent crushing, the capsule remains intact and contains whatever toxicant is contained, leaving the non-target predator unscathed. Further, the dose of the toxicant or rate of release, such as by coating, may be made sufficiently specific to the susceptibilities of the Brps that even if an off target species were to break and consume the toxicant, it would not be lethal or disabling to such off target species. Those of ordinary skill in the art could achieve such results without undue experimentation, based on the disclosure provided herein.

In a further embodiment, the pressure sensitive mechanism is a sealed container, such as a capsule, or the like containing the toxicant which has been made susceptible to breakage and release of the contained toxicant when exposed to adequate pressure, by scoring, or designing the capsule from materials or interconnection of materials which on repeat testing preferably inside a surrogate prey, breaks or otherwise cracks to release its contents upon application of constrictive force by a Brp. Naturally, these results could further be confirmed under test conditions with captive Brps and provision of different Trojan prey options.

In a further embodiment, the pressure sensitive mechanism is a sealed container, such as a capsule, or the like, containing adequate amounts of toxicant to specifically euthanize a Brp, which has been made susceptible to breakage and release of the contained toxicant by pressurizing the interior of said capsule containing the toxicant, such that breakage of the capsule occurs upon additive constrictive pressure metered to a particular required additional amount of pressure deliverable only by a certain size, age, or mass of Brp, to essentially burst and release its contents.

In a further embodiment according to this invention, the device according to this invention: (1) is securely fixable to or implantable in a prey of the invasive species; (2) includes a trigger mechanism specific to the invasive species to release a kill mechanism; (3) includes a euthanasia mechanism which, if triggered, selectively kills said invasive species; and (4) a locatable tag, such as a radio frequency transmitter or the like. Those skilled in the art of tracking animals tagged with some form of beacon will be able to provide the most cost-effective technology, now known or which later comes into being.

The tracker may be used for every Trojan prey, to confirm proper operation of the system, or only in a certain percentage of prey.

The kill mechanism may be selected from the group consisting of: a mechanical, an electrical, a chemical mechanism, and combinations thereof. In a preferred embodiment, the kill mechanism is adapted to selectively kill only a member of the invasive species upon being activated by an associated pressure sensor, or tangible operation of the toxicant container, designed to only break upon exposure to a set minimum crushing force. In a further preferred embodiment, the device includes a means for attaching said device to a prey of said species, such as an adhesive pad, a strap, or the like, known in the art, for tagging preferred prey of the invasive species. In a further preferred embodiment, the device is adapted to a species that is a reptile which constricts its prey. In a further preferred embodiment of the device, the species is a python. In a further preferred embodiment of the device, the species is a Burmese python or a reticulated python. In yet a further embodiment of the device, the means for attaching said device to a prey comprises a harness for attaching to the toxicant container to the prey such that when a Burmese or reticulated python constricts the prey, the at least one pressure sensor activates or the frangible toxicant container breaks, releasing the kill mechanism, without becoming detached from the prey. In a further embodiment of the device and system, the prey is a mammal. In a preferred embodiment of the device, system, and method of this invention, the mammal is selected from the group consisting of: a rodent, a marsupial, or a Procyon. In a yet further preferred embodiment of the device, said device further comprises an electronic means for locating said device, such as a radio frequency emitter or the like known in the art to make location of any pythons that have consumed prey according to this invention and which have died as a result. In yet a further preferred embodiment, the toxicant is coated with an enteric coating known in the art to be dissolved in the long digestive tract of a python, but which is passed without breaking or releasing toxicant or dissolving all of the enteric coating, in a mammal or other potential consumer of a prey tagged with a releasable toxicant.

In a preferred embodiment, the invention is a system or method for controlling the spread of a species comprising breeding large numbers of prey of the invasive species, deploying into a location where said species is invasive a plurality of prey of said species, wherein to each said prey, at least one device has been attached, wherein each said at least one device comprises: (i) at least one pressure sensor; and (ii) at least one kill mechanism operatively coupled to said pressure sensor, such that said at least one kill mechanism is only activated upon said pressure sensor sensing a pre-determined pressure, and wherein said kill mechanism is adapted to kill the species sought to be controlled; such that, when said species captures a prey with said attached device, upon imposing compressive force on said prey adequate to cause said pressure sensor to activate said kill mechanism. In an alternate embodiment, the toxicant that is released prevents the target species from reproducing, and thus killing of the python is not required. One such approach might include using a contraceptive or pheromone mixture which would render the python sterile. In a preferred embodiment, said kill mechanism is selected from the group consisting of: a mechanical, an electrical, and a chemical mechanism. It is further preferred that said kill mechanism is adapted to kill only a member of said invasive species upon being activated by said pressure sensor. The method may include attaching said device to a prey of said species and releasing said prey into the wild to potentially encounter said species. In one embodiment, the species is a reptile which constricts its prey, such as a python. The means for attaching said device to a prey in one embodiment, comprises a harness for attaching to said prey such that when a python constricts said prey, said at least one pressure sensor activates said kill mechanism, without becoming detached from said prey. In a preferred embodiment, the pressure sensor is a container of a toxicant wherein the container has been scored, or otherwise weakened to break and release toxicant upon being subjected to adequate pressure. The prey may be a mammal, such as a rodent, a marsupial, and a Procyon (raccoon, opossums,. In one embodiment, a GPS or radio frequency beacon is attached to the prey. In another embodiment, the toxicant container is introduced sub-dermally, or subcutaneously, in a location on said prey where the crushing force of a python results in breaking of the sealed toxicant container to release the toxicant. Raccoons and opossums are common creatures to most habitats, and are a desired prey for pythons.

Those skilled in the art, based on the present disclosure, are able to experiment with different doses and toxicants than acetaminophen, which are effective in killing an invasive species of interest. Likewise, with respect to various pressure sensitive toxicant release mechanisms, and enteric coating, should that be included. Furthermore, constructs and toxicants based on this disclosure may be defined which are not susceptible to, for example, breakage by an alligator, and if broken, which would not adversely affect the gator. As the present invention stands, those skilled in the art are able to conduct routine experimentation to maximize bait attractiveness and lethality to pythons, while being less attractive to gators, not being toxic to gators, or if taken by a gator, it being very unlikely that a gator, which captures prey, drags and rolls with it in the water and then secretes the prey to rot. In that process, the present invention's device would become dis-associated with the prey, particularly if a simple capsule containing toxicant is pressure calibrated for python compression. Further, if the capsule is small enough, as disclosed in the present disclosure, this further reduces the chances of off-target animals being adversely affected by this device, system, and method. Accordingly, the probability of gators taking bait as disclosed herein and serendipitously crushing the device of this invention is considered is considered low, and routine experimentation may reduce this probability further.

Other toxicants which may be considered, when in the field specificity to pythons is confirmed, including but not limited to: strychnine, calcium cyanide, release of a toxic gas, or use of certain insecticides has likewise been reported.

Referring now to the figures, FIG. 1A shows a 1081 g juvenile Burmese python (Python molurus bivittatus) constricting a lab rat (Rattus norvegicus) weighing 99 g, the constricting python coiling around and squeezing prey animals, which exerts pressure on the prey that scales positively with snake diameter; FIG. 1B shows the scaling relationship between peak constriction pressure and snake diameter. See Penning.

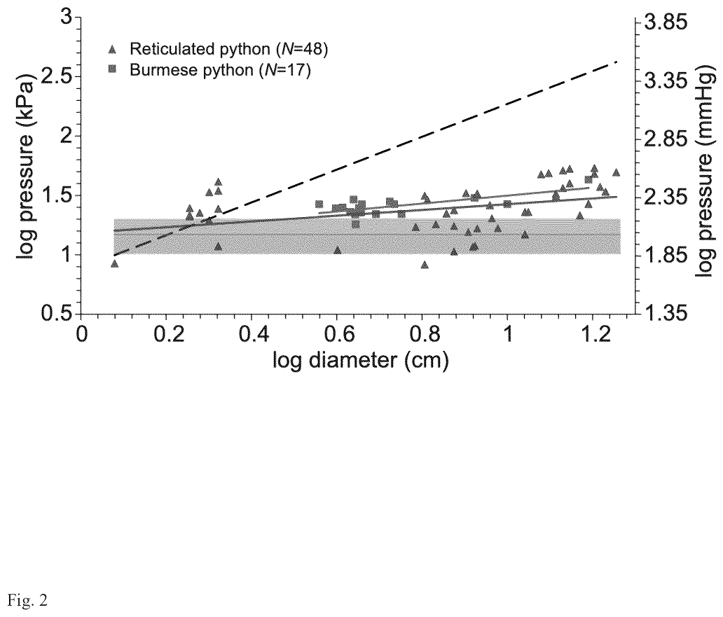

FIG. 2 show constriction pressure which scales differently in Python reticulatus and P. molurus bivittatus than in other species. The interspecific slope (dashed line) from Moon and Mehta (2007) represents 30 snakes from 12 species, ranging in size from 0.85 to 12.5 cm in diameter. Blood pressure values (top bar, systolic; bottom bar, diastolic) are from mice, rats, rabbits, sheep and humans (Flindt, 2003). See Penning.

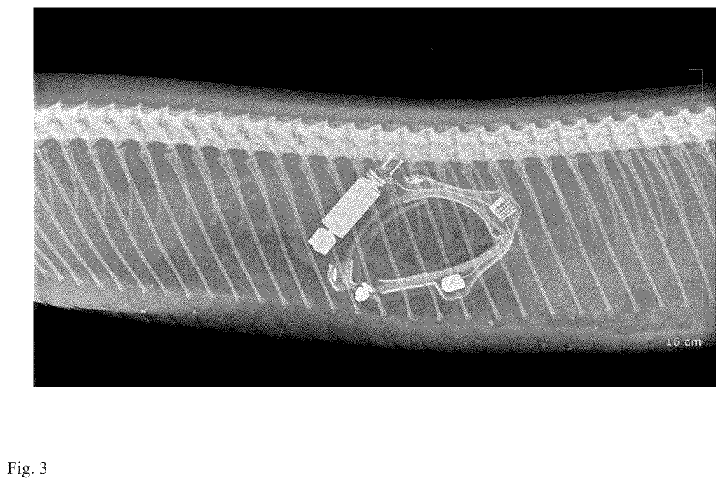

FIG. 3 shows an X-ray image of a GPS-collar, which once sat around the neck of a possum, inside a dead Burmese python that swallowed the small mammal. (Image credit: Southern Illinois University). See https://www.nbcmiami.com/news/local/pythons-tracked-across-florida-by-eaten-possums-with-gps-collars/2977643/. This shows that such collars are known in the art and do remain attached to prey that is consumed by pythons. The key now, according to this invention, is to release toxicant upon python-specific pressure metrics as defined herein and through further routine experimentation.

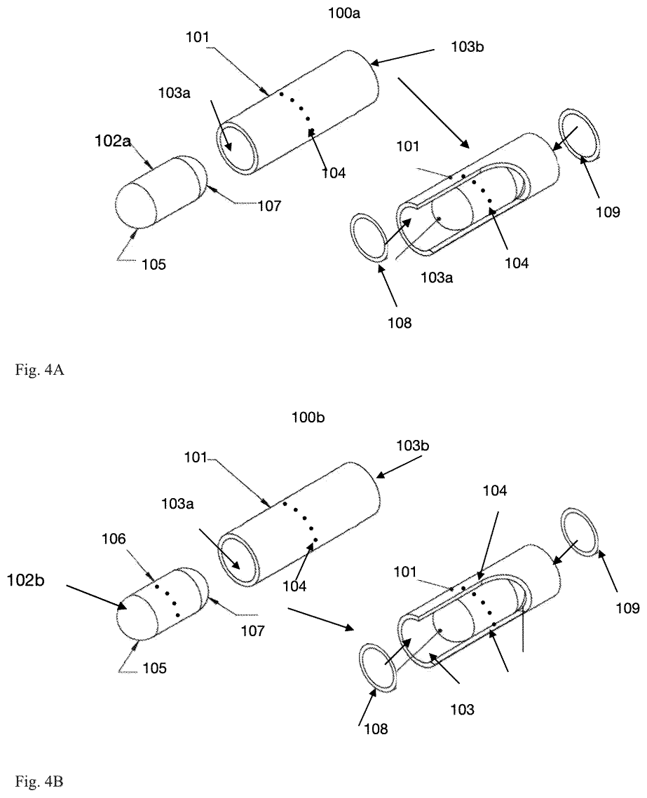

FIG. 4A shows a first embodiment of the device and system according to this invention, in which only the sealed protective sheath is scored to be subject to pressure specific release of the toxicant, while in FIG. 4B, both the toxicant container/capsule, and the protective sheath are scored, to ensure release. The capsule itself may seal in the toxicant until crushed, without the need for a sheath.

In the FIG. 4A, embodiment, there is shown a device and system 100a, which includes a substantially cylindrical sheath 101 and a capsule 102a sealed at both ends 105 and 107, which is inserted into sheath 101 and which is sealed at both ends thereof with plugs 108 and 109. In this embodiment, sheath 101 is scored or otherwise weakened and rendered frangible at 104, with specific break or crush susceptibility having been experimentally defined by implanting the assembled device into or affixing the assembled device onto a deceased prey, for example, and calibrating the crush or break susceptibility to a defined lower limit which ensures that an adult python is crushing the sheath before the capsule and its contents are released. In the embodiment shown in FIG. 4B, a capsule 100b itself may be subject to crushing before release of contained toxicant, e.g. acetaminophen, by scoring or otherwise weakening to render it frangible at 106, with specific break or crush susceptibility having been experimentally defined. In addition, or alternatively, as in the embodiment shown in FIG. 4A, both the sheath and the capsule containing the toxicant may be used, and both may be rendered susceptible to known crush or break pressure.

As noted above and in the figures, reticulated pythons exerted maximum pressures of 8.27-53.77 kPa, with larger individuals exerting significantly higher peak pressures than smaller individuals (constriction pressure=15.17+diameter×1.39; R²=0.29, F_{1,46}=19.06, P<0.0001. Burmese pythons constricted with maximum pressures of 18.0-42.93 kPa, with larger individuals exerting significantly higher peak pressures than smaller individuals (constriction pressure=17.7+diameter×1.42; R²=0.61, F_{1,15}=26.56, P<0.0002. Accordingly, those skilled in the art are enabled to define toxicant containment means, as disclosed herein, able to sustain pressures of about 8 kPa to about 42 kPa, inclusive, and any intermediate pressure, such as 10, or 15, or 20, or 25, 0r 30 or 35 or 40 or 42 kPa. Those skilled in the art will appreciate that through routine experimentation, based on the present disclosure, adequate toxicant release pressures may be defined empirically using toxicant containers with varying crush resistance, including if necessary, outside the range of 8 to 42 kPA.

Those skilled in the art will appreciate that the toxicant container defined herein may be a dissolvable capsule, made from gelatin or the like, which when the outer protective sheath is broken by pressure, is exposed to python digestive juices to release the contained toxicant. Alternatively, the capsule itself may be pressure sensitive and made from a non-dissolvable material, such as a plastic, with a defined crush resistance which, when exceeded, releases toxicant. The outer sheath may likewise be made from a non-dissolving or slowly dissolving crush resistant material, which only crushes and releases toxicant when a defined crush or compression pressure is imposed. n While acetaminophen is known to be an effective toxicant for pythons, based on the present device, method and system, provided is proves out in the field to be specific to pythons, any of a number of other toxicants lethal to the python may be selected.

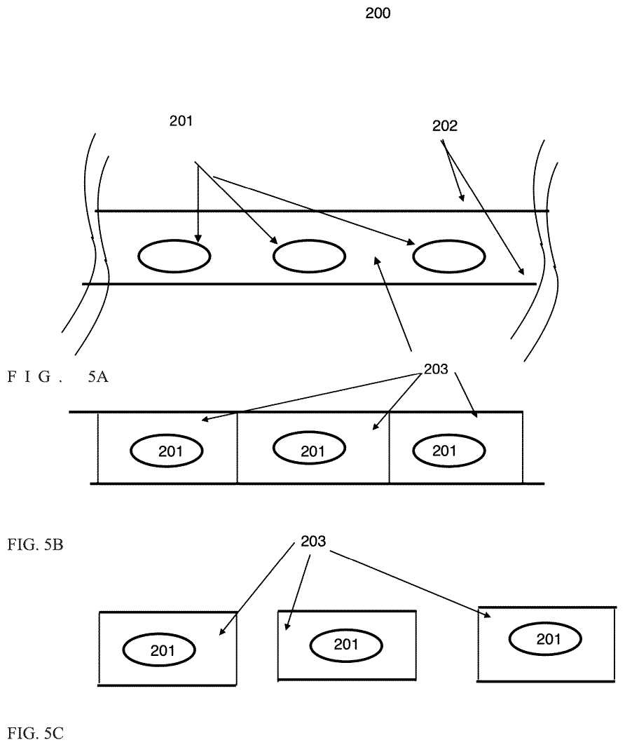

FIG. 5A shows a further embodiment 200 of this invention in which a tube 202 is seeded with toxicant 201 at regular intervals, such as acetaminophen, within the lumen 203, of the tube, and the entire tube is pressurized to a defined pressure. FIG. 5B shows the segmentation of the tube 202 into pressurized, capsules each containing toxicant 201. FIG. 5C shows individually separated sealed capsules each having a lumen under pressure 203 and toxicant 201, which can be associated with a prey or implanted subcutaneously, or if a synthetic prey, incorporated in a position where the capsule will experience constrictive pressure, such that added constriction pressure causes each capsule to pop or explode, releasing the toxicant into the prey which is then consumed by the Brps resulting in the euthanasia of said Bprs.

From the present disclosure, those skilled in the art are enabled to make and use a pressure sensitive trigger mechanism to release a toxicant specific to an invasive species which toxicant is affixed to or implanted into a prey of said invasive species. In various non-limiting specific embodiments, the invention is a device to selectively control the spread of Burmese pythons or reticulated pythons, (“Brps”) comprising: a Brps specific trigger mechanism in operative association with a Brps specific kill mechanism such that when said Brps triggers said trigger mechanism, said kill mechanism is activated; and a Brps specific kill mechanism in operative association with said Brps specific trigger mechanism and that the device can be affixed to or implanted into a prey animal or synthetic prey of said Brps A synthetic prey is any surrogate of a prey of the Brps that is man made. The device is implanted into the prey or synthetic prey animal or affixed to a harness which is attached to the prey animal or synthetic prey animal such that device is subjected to constrictive pressure by the Brps adequate to trigger the trigger mechanism to activate the kill mechanism upon constricting and then consuming the prey animal or synthetic prey animal.

In some embodiments, the device's trigger mechanism is a pressure sensor or pressure sensitive toxicant container which is preferably only activated upon the pressure sensor sensing or experiencing a pre-determined pressure known to correspond with the constriction pressure applied by a particular age or size of Brps. In preferred embodiments, the kill mechanism is selected from a mechanical mechanism, an electrical mechanism, a chemical mechanism and combinations thereof. In preferred embodiments, the prey is a mammal or a synthetic mammal such as a rodent, a marsupial, or a Procyon or a synthetic surrogate of any of these. In some embodiments, the device includes an electronic means for locating device. Those skilled in the art are well aware of such means, including but not limited to wifi, Bluetooth, radiofrequency transmission and reception, or the like. In a preferred embodiment, the device is a sealed capsule which operates as a Brps specific trigger mechanism which is a pressure sensitive sealed capsules selected such that it is either crushed or popped upon being constricted by Brps such that said sealed capsule becomes unsealed, releasing or exposing capsule's contents. In a preferred embodiment, the capsule's contents comprises a chemical in sufficient quantity to kill said Brps when said device is unsealed and is ingested by said Brps. Those skilled in the art know how to measure pressures when applied to an object such as the sealed capsule described herein. Those capsules that pop, or rupture, or explode, or break, or are crushed at a particular constriction pressure known to be exerted by Brps of a certain age or size, are selected for use according to this invention. In a preferred embodiment, the pressure-sensitive sealed capsule contains a toxicant. In some embodiments, the sealed capsule is itself internally pressurized such that upon being constricted by Brps, the capsule pops, explodes, or ruptures to release the toxicant into the prey such that upon consumption of the prey, the Brps is euthenized.

In some embodiments, the kill mechanism includes a toxicant contained within a capsule wherein the toxicant, the capsule or both are enterically coated so as to be susceptible to dissolving in the digestive tract of a Brps but not in the digestive tract of a mammal. Preferably, the toxicant is essentially non-toxic to mammalian species, or a dose of toxicant is used which is toxic to the Bprs but not to any off-target species.

In other embodiments, the invention is amethod for controlling the spread of invasive Brps which includes implanting in or securely attaching to a prey of Brps at least one device which includes a Brps specific trigger mechanism in operative association with a Brps specific kill mechanism such that when the Brps triggers the trigger mechanism, the kill mechanism is activated, deployed or released. In some embodiments of the method, the Brps specific kill mechanism in operative association with the Brps specific trigger mechanism.

In a preferred embodiment, a plurality of the prey of invasive Brps in a region where the Brps is an invasive, non-endogenous species which results in destruction of the ecosystem. Each prey included in the plurality of prey is equipped with an attached or inserted device which includes a Brps specific trigger mechanism, such as a sealed capsule susceptible to breakage, rupture or popping upon application of pressure by Brps, and at least one kill mechanism which is only activated or released when a pre-determined pressure is applied by the Brps sought to be controlled when the Brps captures and constricts and then consumes such prey with the implanted or attached device. In a preferred embodiment, the Brps specific kill mechanism is acetaminophen.

In a further embodiment, the invention is a system which includes a trigger mechanism securely fixed to or subcutaneously implanted in a prey of Brps; and a kill mechanism which selectively kills the Brps upon triggering the trigger mechanism by constriction of and consumption of the prey. In a preferred embodiment, the kill mechanism includes a toxicant contained within a capsule wherein the toxicant, the capsule or both are enterically coated so as to be susceptible to dissolving in the digestive tract of Brps but not in the digestive tract of a mammal or other off-target species. In a preferred embodiment, the toxicant is essentially non-toxic to mammalian species at the dosages required to kill Brps. Preferably, the capsule, in addition to the toxicant for the Brps also includes a substance to make the crushing and consumption of the prey as painless to the prey as possible. Acetaminophen is a nonsteroidal anti-inflammatory agent which provides some pain suppression. However, if in addition to the toxicant, the capsule includes one or more anesthetics which, upon rupture of the pressure sensitive capsule, causes the prey to become insensitive to pain. Compounds such as propofol, remifentanil, fentanyl, ketamine, or the like may be included in the capsule.

In preferred embodiment, the device as described herein includes a trackable beacon, or wherein the device is used in combination with a trackable beacon, so that once killed, the killed Bprs can be found, confirmed, and counted. Such form of tagging devic is attached to or is implanted into the prey.

In some embodiments, the system includes the device of this invention to selectively contain the spread of Brps securely fixable to or implantable in a prey of Bprs which includes a trigger mechanism specific to Bprps and a Brps kill mechanism which selectively kills said Brps following constriction and consumption of the prey.

Those skilled in the art will also appreciate that the prey according to this invention may be euthanized prior to release as bait-but it is anticipated that live bait is preferred and can be bred for this purpose. However, as described above, the prey may be anesthetized or even euthanized upon release of the toxicant. It will also be appreciated that even if a species is endogenous to an area, it may still become defined as an invasive species if it is invading territories where it has not before been endogenous or to which spread is not acceptable by humans (the ultimate invasive species for which unrestrained population growth is likewise a problem).

Those skilled in the art will appreciate, from this disclosure, that variations and equivalents, permutations and combinations of the various embodiments of the invention provide a method, system, and device according to this invention. Such variants, equivalents, permutations and combinations may be without departing from the scope of the attached claims.

What is claimed is:

1. A device to selectively control the spread of Burmese pythons or reticulated pythons, (“Brps”) comprising:
a. a Brps specific trigger mechanism in operative association with a Brps specific kill mechanism such that when said Brps triggers said trigger mechanism, said kill mechanism is activated; and
b. a Brps specific kill mechanism in operative association with said Brps specific trigger mechanism.

2. The device according to claim 1 wherein said device is affixed to a prey animal or synthetic prey of said Brps.

3. The device according to claim 2 wherein said device is implanted into said prey or synthetic prey animal or affixed to a harness which is attached to said prey animal or synthetic prey animal such that said device is subjected to constrictive pressure by said Brps adequate to trigger said trigger mechanism to activate said kill mechanism upon constricting and then consuming said prey animal or synthetic prey animal.

4. The device according to claim 3 wherein said trigger mechanism is a pressure sensor or pressure sensitive toxicant container.

5. The device according to claim 4 wherein said kill mechanism is only activated upon said pressure sensor sensing or experiencing a pre-determined pressure.

6. The device according to claim 1 wherein said kill mechanism is selected from the group consisting of: a mechanical mechanism, an electrical mechanism, a chemical mechanism and combinations thereof.

7. The device according to claim 6 wherein said prey is a mammal or a synthetic mammal.

8. The device according to claim 7 wherein said mammal is selected from the group consisting of: a rodent, a marsupial, or a Procyon or a synthetic surrogate of said group.

9. The device according to claim 1 further comprising an electronic means for locating said device.

10. The device according to claim 1 wherein a sealed capsule operates as said Brps specific trigger mechanism is a pressure sensitive sealed capsules selected such that it is either crushed or popped upon being constricted by said Brps such that said sealed capsule becomes unsealed, releasing or exposing said capsule's contents.

11. The device according to claim 10 wherein said capsule's contents comprise a chemical in sufficient quantity to kill said Brps when said device is unsealed and is ingested by said Brps.

12. The device according to claim 10 wherein said pressure-sensitive sealed capsule contains a toxicant and wherein said sealed capsule is itself internally pressurized such that upon being constricted by said Brps, said capsule pops, explodes, or ruptures to release said toxicant into said prey such that upon consumption of said prey, said Brps is euthenized.

13. The device according to claim 1 wherein said kill mechanism comprises a toxicant contained within a capsule wherein said toxicant, said capsule or both are enterically coated so as to be susceptible to dissolving in the digestive tract of a snake but not in the digestive tract of a mammal, and wherein said toxicant is essentially non-toxic to mammalian species, or a dose of said toxicant is used which is toxic to the Bprs but not to any off-target species.

14. A method for controlling the spread of invasive Brps comprising:
implanting in or securely attaching to a prey of said Brps at least one device, wherein each said at least one device comprises: i. a Brps specific trigger mechanism in operative association with a Brps specific kill mechanism such that when said Brps triggers said trigger mechanism, said kill mechanism is activated; and ii. a Brps specific kill mechanism in operative association with said Brps specific trigger mechanism.

15. The method of claim 14 comprising deploying a plurality of said prey of said invasive Brps in a region where said Brps is an invasive species, said Brps specific trigger mechanism is a sealed capsule susceptible to breakage, rupture or popping upon application of pressure to said device, and at least one kill mechanism which is only activated or released when a pre-determined pressure is applied by said Brps sought to be controlled when said Brpsio captures and constricts and then consumes said prey with said implanted or attached device, and wherein said Brps specific kill mechanism is acetaminophen.

16. A system comprising:
a. a trigger mechanism securely fixed to or subcutaneously implanted in a prey of Brps; and
b. a kill mechanism which selectively kills said Brps upon triggering said trigger mechanism by constriction of and consumption of said prey.

17. The system according to claim 16 wherein said kill mechanism comprises a toxicant contained within a capsule wherein said toxicant, said capsule or both are enterically coated so as to be susceptible to dissolving in the digestive tract of Brps but not in the digestive tract of a mammal or other off-target species, and wherein said toxicant is essentially non-toxic to mammalian species at the dosages required to kill said Brps.

18. The system according to claim 17 wherein said toxicant is acetaminophen.

19. The system according to claim 18 further comprising a tagging device which is attached to or is implanted into said prey.

20. The system comprising the device of claim 1 to selectively contain the spread of said Brps securely fixable to or implantable in a prey thereof which includes a trigger mechanism specific to said Bprps which releases a Brps kill mechanism which selectively kills said Brps following constriction and consumption of said prey.
